(19) United States
(12) Patent Application Publication
(10) Pub. No.: US 2026/0266745 A1
(43) Pub. Date: Sep. 10, 2026

(54) SECONDARY IMAGE REMOVAL USING HIGH RESOLUTION X-RAY TRANSMISSION SOURCES

(71) Applicant: Sigray, Inc., Benicia, CA (US)

(72) Inventors: Sylvia Jia Yun LEWIS, San Francisco, CA (US); Sheraz GUL, San Ramon, CA (US); Wenbing YUN, Walnut, CA (US)

(21) Appl. No.: 19/677,110

(22) Filed: May 14, 2026

Related U.S. Application Data
(63) Continuation of application No. 19/308,130, filed on Aug. 22, 2025.
Application No. 19/308,130 is a reissue of application No. 18/406,851, filed on Jan. 8, 2024, now Pat. No. 12,181,423.
(60) Provisional application No. 63/581,225, filed on Sep. 7, 2023.

(51) Int. Cl. G01N 23/046; G01N 23/083

(52) U.S. Cl. CPC G01N 23/046; G01N 23/083; G01N 2223/204; G01N 2223/317; G01N 2223/3306; G01N 2223/505

(57) ABSTRACT

An apparatus includes a transmission x-ray source having a window including a target layer of at least one x-ray generating material and an internal aperture configured to allow a first portion of an electron beam to bombard the target layer and to block a second portion of the electron beam from bombarding the target. The first portion of the electron beam has a full-width-at-half-maximum width at the target less than or equal to 1 micron. The window is spaced from the internal aperture by a first distance D₁. The apparatus further includes an x-ray detector system having a scintillator, an optical assembly, at least one image sensor configured to receive and respond to visible light by generating electrical signals, and a motorized stage configured to controllably adjust a position of the scintillator such that the scintillator is spaced from the window by a second distance D₂, wherein

$${D}_{2}^{2} / {( {D}_{1} + {D}_{2} )}^{2}$$

is less than 0.2.

### CLAIM OF PRIORITY

This application is a continuation application of U.S. application Ser. No. 19/308,130, filed Aug. 22, 2025, which is a reissue of U.S. application Ser. No. 18/406,851, filed Jan. 8, 2024, now U.S. Pat. No. 12,181,423, which claims the benefit of priority to U.S. Provisional Appl. No. 63/581,225 filed Sep. 7, 2023, which is incorporated in its entirety by reference herein.

### BACKGROUND

### Field

This application relates generally to transmission x-ray sources and x-ray imaging systems.

### Description of the Related Art

In high resolution transmission x-ray sources, a physical aperture can be used to reduce the area of the x-ray target impinged (e.g., bombarded) by the electron beam. Such apertures can occlude a portion of the electron beam from reaching the x-ray target, allowing the x-ray sources to achieve electron beam spots with submicron diameters at the x-ray target. For example, FIG. 1 schematically illustrates a cross-sectional view of a conventional transmission x-ray source 10 with an aperture 12 and an electron beam 14 propagating along an electron beam propagation axis 15 and impinging an x-ray target 16 on an x-ray window 18. A first portion 14a of the electron beam 14 propagates through the hole of the aperture 12 to impinge the x-ray target 16, generating primary x-rays 20 from the x-ray target 16 that propagate out of the x-ray source 10 through the x-ray window 18. A second portion 14b of the electron beam 14 impinges the solid portion of the aperture 12 and is prevented from impinging the x-ray target 16. However, by impinging the solid portion of the aperture 12, the second portion 14b of the electron beam 14 can generate secondary x-rays 22 (e.g., generated directly by the electron beam 14 impinging the solid portion of the aperture 12). Additional secondary x-rays 22 can be generated by backscattered electrons from the x-ray target 16 impinging the solid portion of the aperture 12. The angular distribution of the secondary x-rays 22 emanating from the x-ray source 10 can be narrower than the angular distribution of the primary x-rays 20 emanating from the x-ray source 10. In x-ray imaging using such an x-ray source 10, the secondary x-rays 22 can create a “secondary image” of a sample in the center of a tomography dataset, the smaller secondary image superimposed upon a larger volume of the “primary image.”

Although the secondary image exists in most high-resolution x-ray sources with an aperture 12 and microns-scale focus (e.g., spot size or width greater than or equal to 2 microns), the secondary image can be particularly pronounced for x-ray sources 10 with submicron focal spot sizes or widths (e.g., less than 1 micron) because the metal x-ray target 16 (e.g., tungsten film) that generates the primary x-rays 20 can be thin (e.g., thickness in a range of 500 nanometers to 2 microns). When such x-ray sources 10 are operated at higher accelerating voltages, most of the electrons are too energetic to strongly interact with the thin metal x-ray target 16 and the primary x-ray generation is low, leading to a higher secondary-to-primary ratio. Furthermore, when such x-ray sources 10 are operated with smaller apertures for smaller spot sizes, more x-rays can be intercepted by the aperture 12 which also leads to higher secondary-to-primary ratios. For example, secondary x-rays 22 can be up to 20% of the total x-rays, resulting in significant degradation to image quality. These secondary x-rays 22 can also degrade the resolution of the x-ray imaging system.

External apertures can be used with larger spot size x-ray sources (e.g., spot size greater than or equal to 2 microns) to remove (e.g., block) these secondary x-rays 22. However, such external apertures are not used for most high resolution applications since (i) an external aperture can increase the source-to-sample distances resulting in lower throughput and (ii) the increase of the minimum source-to-sample distance can result in larger overall system lengths to achieve higher resolution (e.g., to achieve geometric magnifications of 1000×, a minimum 2-millimeter source-to-sample distance would have an overall system length over 2 meters, while a 1-millimeter source-to-sample distance would have an overall system length over 1 meter).

X-ray source manufacturers have devised solutions that utilize “beam blanking” by moving an electron beam 14 over an edge separating two regions of a structured x-ray target 16 that have different capacities to generate x-rays 20 (see, e.g., U.S. Pat. No. 10,784,069) and generating a separate “secondary” beam image to subtract the contribution to the image from the secondary x-rays 22. However, such solutions also have challenges. For example, this approach often sweeps the electron beam 14 between a tungsten target region and a low atomic number (e.g., diamond; beryllium) non-target region. Because the amount of secondary x-rays 22 resulting from backscattered electrons from the x-ray target 16 can be dependent on the target material being impinged, the target and non-target regions will not have 1:1 equivalence with regard to secondary x-rays 22. Furthermore, the deflection of the electron beam 14 from the target region to the non-target region can cause differences in the positions from which secondary x-rays 22 are produced and in the amounts of secondary x-rays 22 that are produced. In addition, the profiles of the electron beam 14 on the metal target layer 16 and a deflected electron beam 14 on the low Z non-target material can be different, resulting in differences that cannot be subtracted in a straightforward manner. In such cases, the image created by the secondary x-rays 22, while reduced, can still remain and cause problems.

Moreover, the secondary x-ray problem can be exacerbated by using standard x-ray detectors. Most micro-computed tomography (“microCT”) imaging systems use detectors with pixel sizes in a range of about 50 microns to 100 microns (e.g., flat panel detectors). Due to the large pixel sizes of these detectors, to achieve high resolution imaging, the detector is used at a large distance from the x-ray source 10 (e.g., the detector at least 100 millimeters from the sample to achieve 0.5-micron resolution for a 50-micron detector pixel). At small distances from the x-ray source 10 (e.g., less than 10 millimeters), the ratio of secondary x-rays 22 to primary x-rays 20 is low, but the ratio of secondary x-rays 22 to primary x-rays 20 increases as the detector is moved to larger distances from the x-ray source 10.

### SUMMARY

In one aspect disclosed herein, an apparatus comprises a transmission x-ray source and an x-ray detector system. The transmission x-ray source comprises a window comprising a target layer of at least one x-ray generating material configured to generate x-rays in response to bombardment by electrons. The transmission x-ray source further comprises an internal aperture configured to allow a first portion of an electron beam from an electron beam source to bombard the target layer and to block a second portion of the electron beam from bombarding the target layer. The first portion of the electron beam has a full-width-at-half-maximum width at the target layer less than or equal to 1 micron. The window is spaced from the internal aperture by a first distance D₁. The x-ray detector system comprises a scintillator configured to receive x-rays from the x-ray source that have propagated through a sample and to respond to the received x-rays by generating visible light. The x-ray detector system further comprises an optical assembly configured to receive the visible light from the scintillator. The x-ray detector system further comprises at least one image sensor configured to receive and respond to the visible light from the optical assembly by generating electrical signals. The x-ray detector system further comprises a motorized stage configured to controllably adjust a position of the scintillator such that the scintillator is spaced from the window by a second distance D₂, wherein

$${D}_{2}^{2} / {( {D}_{1} + {D}_{2} )}^{2}$$

is less than 0.2.

In another aspect disclosed herein, an apparatus comprises an x-ray source, a sample stage configured to support and controllably move a sample, and at least one x-ray detector. The x-ray source comprises an electron beam source configured to generate an electron beam, at least one aperture, at least one target, and a window. The at least one aperture is configured to allow a first portion of the electron beam to propagate through the at least one aperture and to block a second portion of the electron beam from propagating through the at least one aperture. The at least one target comprises at least one x-ray generating material configured to generate a first diverging x-ray beam in response to bombardment by the first portion of the electron beam. The at least one aperture is configured to generate a second diverging x-ray beam in response to bombardment by the second portion of the electron beam and/or by electrons backscattered from the at least one target. The window is configured to emit the first x-ray beam and the second x-ray beam, both the first x-ray beam and the second x-ray beam substantially centered on an x-ray axis that is substantially perpendicular to an outer surface of the window. The at least one x-ray detector is configured to receive x-rays of the first x-ray beam transmitted from the x-ray source and through a region-of-interest of the sample along a central beam axis, the central beam axis and the x-ray axis having an angle Ø greater than or equal to 6 degrees therebetween.

In another aspect disclosed herein, an apparatus comprises a transmission x-ray source configured to generate a primary x-ray beam having a first cone angle Θ₁ and a secondary x-ray beam having a second cone angle Θ₂ less than the first cone angle Θ₁, both the primary x-ray beam and the secondary x-ray beam diverging and symmetric about an x-ray axis. The apparatus further comprises a sample stage configured to support and controllably move a sample. The apparatus further comprises at least one x-ray detector having a region configured to receive x-rays transmitted from the transmission x-ray source and through a region-of-interest of the sample along a beam axis at a non-zero angle @ relative to the x-ray axis. The at least one x-ray detector is configured to generate electrical signals indicative of the x-rays received at the region.

In another aspect disclosed herein, an apparatus comprises an electron beam source configured to generate an electron beam, an aperture, and a target. The aperture comprises a first solid portion comprising at least one first atomic element having a first atomic number greater than 20 (e.g., at least 50% of the first solid portion is the at least one first atomic element), a hole extending through the first portion, and a second solid portion overlaying at least one surface of the first solid portion (e.g., at least one layer coated onto a first surface region facing towards the electron beam source, a second surface region extending at least partly into the hole, and/or a third surface region facing away from the electron beam source). The second solid portion comprises at least one second atomic element having a second atomic number less than 15 (e.g., at least 50% of the second solid portion is the at least one second atomic element; configured to block at least 50% of an electron flux impinging the second solid portion from reaching the first solid portion). The target is configured to generate x-rays in response to being impinged by electrons of the electron beam. The aperture is configured to allow a first portion of the electron beam to propagate through the hole to impinge the target and to occlude a second portion of the electron beam from propagating through the hole. The second portion of the electron beam impinges the second solid portion. In certain aspects, the apparatus can further include a vacuum chamber containing a vacuum region, the electron beam source configured to transmit the electron beam into the vacuum region, the vacuum chamber containing the electron beam source, the aperture, and the target. For example, the vacuum chamber can comprise a window separating the vacuum region from a non-vacuum region outside the vacuum chamber, the window consisting essentially of one or more atomic elements having atomic numbers less than 15, the target comprising at least one metal layer in thermal communication with a surface of the window that is facing the vacuum region.

### BRIEF DESCRIPTION OF THE DRAWINGS

FIG. 1 schematically illustrates a cross-sectional view of a conventional transmission x-ray source with an aperture and an electron beam impinging an x-ray target on an x-ray window.

FIGS. 2A and 2B schematically illustrate cross-sectional views of two examples of a transmission x-ray source in accordance with certain implementations described herein.

FIG. 3A schematically illustrates a cross-sectional view of another example of a transmission x-ray source in accordance with certain implementations described herein.

FIGS. 3B and 3C show an x-ray image and an x-ray lineout, respectively, of a portion of an example first diverging x-ray beam and an example second diverging x-ray beam 240 in accordance with certain implementations described herein.

FIG. 3D schematically illustrates an example x-ray source with a substantially conical snout in accordance with certain implementations described herein.

FIGS. 4A-4B schematically illustrate cross-sectional views of two examples of a transmission x-ray source in accordance with certain implementations described herein.

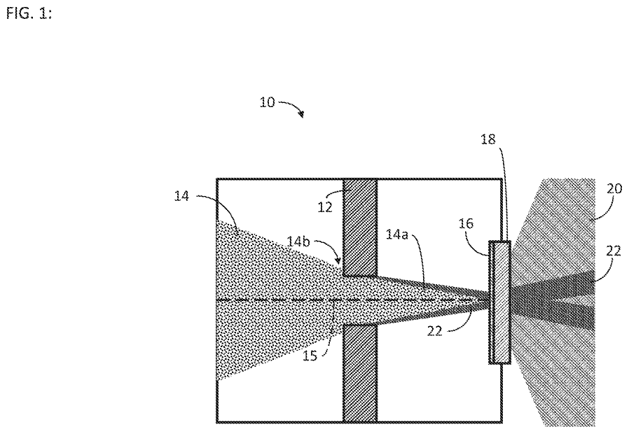

### DETAILED DESCRIPTION

Certain implementations described herein provide various hardware approaches to reduce (e.g., remove) the secondary image produced by secondary x-rays from a high resolution transmission x-ray source.

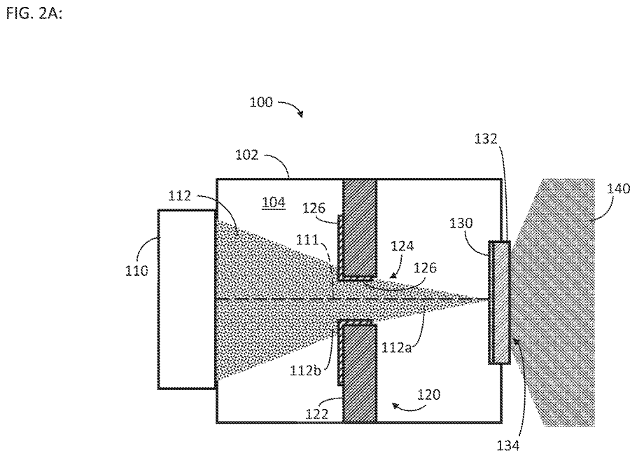

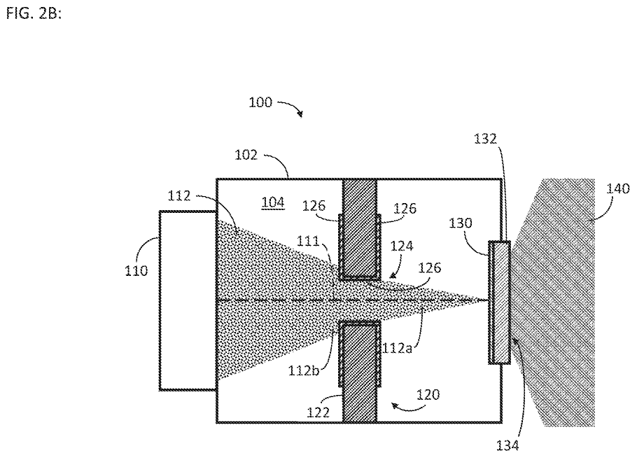

FIGS. 2A-2B schematically illustrate cross-sectional views of two examples of a transmission x-ray source 100 in accordance with certain implementations described herein. The example x-ray source 100 comprises an electron beam source 110 configured to generate an electron beam 112 (e.g., propagating along an electron beam propagation axis 111), an aperture 120, and a target 130 configured to generate x-rays 140 in response to being impinged (e.g., bombarded) by electrons of the electron beam 112. The aperture 120 comprises a first portion 122 comprising at least one first atomic element having a first atomic number greater than 20 (e.g., greater than 40), a hole 124 extending through the first portion 122, and a second portion 126 overlaying at least one surface of the first portion 122, the second portion 126 comprising at least one second atomic element having a second atomic number less than 15. The aperture 120 is configured to allow a first portion 112a of the electron beam 112 to propagate through the hole 124 to impinge the target 130. The aperture 120 is further configured to occlude (e.g., block; inhibit; prevent) a second portion 112b of the electron beam 112 from propagating through the hole 124, the second portion 112b impinging the second portion 126.

In certain implementations, the x-ray source 100 comprises a vacuum chamber 102 (e.g., vacuum-sealed tube) containing a vacuum region 104 and the electron beam source 110 is configured to transmit the electron beam 112 into the vacuum region 104. In certain implementations, the vacuum chamber 102 contains the electron beam source 110, the aperture 120, and the target 130. In contrast to open-tube x-ray sources, the vacuum chamber 102 of certain implementations is not actively pumped.

In certain implementations, the electron beam source 110 comprises a cathode configured to emit electrons and electron optics (e.g., electrodes; electromagnetic focusing column) configured to direct the electrons into the electron beam 112 (e.g., using accelerating voltages in a range of 30 kVp to 160 kVp) and to direct the electron beam 112 towards the target 130 (e.g., to focus the electron beam 112 at the target 130). For example, the electron beam source 110 can be configured to generate the focused electron beam 112 and to bombard the target 130 with the focused electron beam 112 with a selectable maximum accelerating voltage at the target 130 in a range from 10 kVp to 250 kVp. The electron beam spot size (e.g., FWHM; width; diameter) at the target 130 (e.g., the x-ray generating spot size) can be less than 2 microns (e.g., in a range of 0.3 micron to 1 micron; less than 1 micron; less than 0.6 micron; less than 0.5 micron; less than 0.3 micron).

In certain implementations, the target 130 is within the vacuum region 104 and is configured to generate diverging x-rays 140 in response to bombardment by electrons of the electron beam 112. The target 130 comprises at least one x-ray generating material selected for its x-ray spectral production properties (e.g., characteristic x-ray energy) and/or other properties (e.g., atomic number Z; electron density) that affect the x-ray production capability of the at least one x-ray generating material. The at least one x-ray generating material can have a sufficiently high thermal conductivity to dissipate heat generated by bombardment by electron beams 112 with high power. The at least one x-ray generating material can have a thermal conductivity greater than or equal to 100 W/mK and/or a melting point greater than 1000° C. (e.g., greater than 2000° C.). Examples of x-ray generating materials include but are not limited to: Cr, Fe, Co, Ni, Cu, W, Rh, Mo, Au, Pt, Ag, SrB₆, LaB₆, CeB₆, other materials containing atomic elements with atomic numbers greater than or equal to 40.

As shown schematically in FIGS. 2A-2B, the target 130 can be affixed to (e.g., integrated with; a component of; in contact with) a vacuum window 132 of the vacuum chamber 102, the vacuum window 132 separating the vacuum region 104 from a non-vacuum region outside the vacuum chamber 102. For example, the target 130 can comprise at least one metal layer in thermal communication with (e.g., affixed to; deposited on) a surface of the vacuum window 132 that is facing the vacuum region of the vacuum chamber 102, and the vacuum window 132 can be connected to electrical ground. The thickness of the at least one x-ray generating material of the target 130 (e.g., along a direction substantially perpendicular to an outer surface 134 of the vacuum window 132) can be less than 15 microns (e.g., in a range of 0.1 micron to 10 microns; in a range of 2 microns to 5 microns; in a range of 0.2 micron to 3 microns; in a range of 0.5 micron to 2 microns; in a range of 200 nanometers to 500 nanometers) and the thickness of the vacuum window 132 in the direction substantially perpendicular to the outer surface 134 of the vacuum window 132 can be in a range of 0.05 millimeter to 3 millimeters. The thickness of the at least one x-ray generating material can be configured to optimize for high spatial resolution (e.g., by minimizing electron beam scatter inside material) and/or for high system throughput (e.g., maximizing electron energy deposition inside the at least one x-ray generating material). In certain implementations, the at least one x-ray generating material has a plurality of regions that can be bombarded by the electron beam 112 (e.g., by translating the electron beam focus), each region having a corresponding thickness along a direction substantially perpendicular to the outer surface 134 of the vacuum window 132. The electron beam 112 can be directed by the electron beam source 110 to bombard a selected region with a corresponding thickness that provides a selected tradeoff between throughput and resolution.

In certain implementations, the vacuum window 132 consists essentially of atomic elements having atomic numbers (Z) less than 15 and is substantially transmissive to higher energy x-rays generated by the at least one x-ray generating material of the target 130. For example, the vacuum window 132 can have a sufficiently high thermal conductivity to provide a thermal conduit to prevent thermal damage (e.g., melting) of the at least one x-ray generating material of the target 130 (e.g., one or more materials of the vacuum window 132 selected from the group consisting of: beryllium, diamond, boron carbide, silicon carbide, aluminum, sapphire, and beryllium oxide (BeO)). The vacuum window 132 can further provide a sufficiently electrically conductive path to dissipate electric charge from the at least one x-ray generating material of the target 130 and/or the vacuum window 132. In certain implementations, the vacuum window 132 is configured to have an x-ray transmission such that more than 50% of the x-rays generated by the target 130 having energies greater than one-half the selected maximum focused electron energy are transmitted through the vacuum window 132.

In certain implementations, the first portion 122 of the aperture 120 comprises a solid, substantially planar slab or plate (see, e.g., FIGS. 2A-2B), while in certain other implementations, the first portion 122 is non-planar (e.g., curved). In certain implementations, at least 50% (e.g., at least 70%; at least 90%) of the first portion 122 is the at least one first atomic element. Examples of the at least one first atomic element of the first portion 122 include but are not limited to: molybdenum; tungsten.

In certain implementations, the hole 124 (e.g., orifice; slit) of the aperture 120 has a width in a direction substantially perpendicular to the electron beam 112 less than 5 millimeters (e.g., less than 4 millimeters; less than 2 millimeters; less than 1 millimeter). Various shapes of the perimeter of the hole 124 are compatible with certain implementations described herein (e.g., circular, oval, rectangular, square, polygonal, symmetric, asymmetric).

In certain implementations, at least 50% (e.g., at least 70%; at least 90%) of the second portion 126 is the at least one second atomic element. Examples of the at least one second atomic element include but are not limited to: carbon (e.g., the second portion 126 comprising a graphite layer, diamond, and/or polymer). The second portion 126 can be electrically conductive and in electrical communication to ground such that an electrical charge of the second portion 126 does not increase by virtue of being impinged by the electrons.

In certain implementations, the second portion 126 of the aperture 120 comprises at least one layer coated onto the at least one surface of the first portion 122. For example, the at least one layer can be coated on a single surface region of the first portion 122 (e.g., a surface region facing towards the electron beam source 110). For another example (see, e.g., FIG. 2A), the at least one layer can be coated on at least two surface regions of the first portion 122 (e.g., a surface region facing towards the electron beam source 110 and a surface region extending at least partly into the hole 124). For another example (see, e.g., FIG. 2B), the at least one layer can be coated on at least three surface regions of the first portion 122 (e.g., a surface region facing towards the electron beam source 110, a surface region extending at least partly into the hole 124, and a surface region facing away from the electron beam source 110). The second portion 126 on the surface region of the first portion 122 facing away from the electron beam source 110 can face towards the target 130 and can inhibit (e.g., reduce; prevent; block) secondary x-rays from being generated by backscattered electrons from the target 130 impinging the first portion 122.

The at least one layer of the second portion 126 can be configured to attenuate over 50% of the electron flux impinging the second portion 126 (e.g., blocking at least 50% of the electron flux impinging the second portion 126 from reaching the first portion 122). For example, the thickness of the at least one layer can be in a range of 50 microns to 300 microns, in a range of 50 microns to 100 microns; in a range of 100 microns to 300 microns; greater than 300 microns. For another example, the thickness of the at least one layer can be greater than or equal to a continuous slowing down approximation (CSDA) length of the mean electron energy of the electrons (e.g., in a range of 30 keV to 150 keV; in a range of 30 keV to 100 keV; in a range of 60 keV to 140 keV; in a range of 80 keV to 120 keV; in a range of 100 keV to 150 keV) in a impinging the second portion 126. Using the NIST ESTAR database of stopping power and range tables for electrons, a CSDA range for 150 keV electrons is 3.174×10⁻² g/cm², corresponding to a CSDA range or thickness for carbon of about 144 microns (e.g., 3.174×10⁻² g/cm² divided by a density of 2.2 g/cm³).

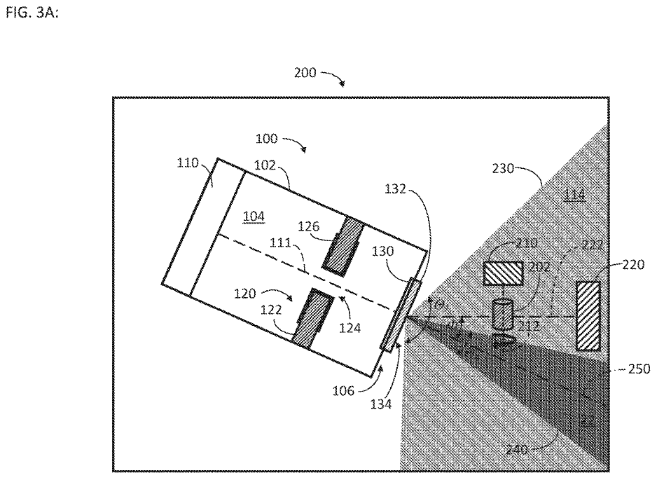

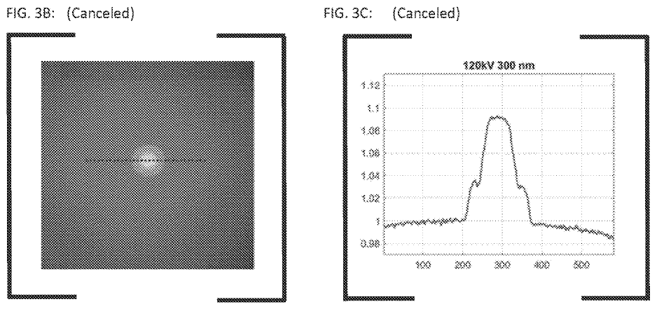

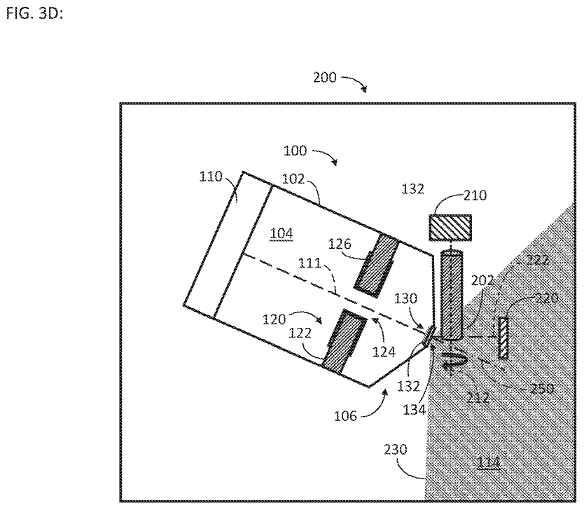

FIG. 3A schematically illustrates a cross-sectional view of another example of a transmission x-ray source 100 in accordance with certain implementations described herein. In certain implementations, the x-ray source 100 comprises an aperture 120 as described herein with regard to FIGS. 2A-2B, while in certain other implementations, the x-ray source 100 does not comprise an aperture 120. The example x-ray source 100 is shown in FIG. 3A as part of an x-ray tomography system 200 comprising a rotational stage 210 and at least one x-ray detector 220. The rotational stage 210 is configured to support and to controllably move a sample 202 (e.g., configured to have a sample 202 mounted thereon and configured to rotate the sample 202 about a rotation axis 212). As schematically illustrated by FIG. 3A, a central beam axis 222 can be defined by a straight line extending from an x-ray generating spot of the target 130, a portion of the sample 202, and a portion of the at least one x-ray detector 220 (e.g., the central beam axis 222 extending through the sample 202 to a center of an effective region of the at least one x-ray detector 220). In certain implementations, the x-ray tomography system 200 comprises additional elements (e.g., x-ray attenuators; x-ray blockers) configured to prevent x-rays that impinge other structures besides the sample 202 (e.g., the rotational stage 210) from reaching the at least one x-ray detector 220.

In certain implementations, the distance between the x-ray source 100 and the at least one x-ray detector 220 is less than 2 meters (e.g., less than 1.5 meters; less than 1 meter; less than 0.75 meter; less than 0.5 meter). In certain implementations, the x-ray tomography system 200 comprises multiple motors configured to move the x-ray source 100 and/or the at least one x-ray detector 220 (e.g., towards and away from the rotation axis 212) to controllably adjust a source-to-sample distance (e.g., distance between the outer surface 134 of the vacuum window 132 and the sample 202) and a sample-to-detector distance (e.g., distance between the sample 202 and an outer surface of the at least one x-ray detector 220 facing the sample 202).

In certain implementations, the x-ray source 100 is configured to generate a first diverging x-ray beam 230 comprising x-rays 140 from the target 130 (e.g., primary x-rays) and a second diverging x-ray beam 240 comprising x-rays 22 generated by the electrons impinging the aperture 120. Both the first x-ray beam 230 and the second x-ray beam 240 are centered about an x-ray axis 250 (e.g., substantially perpendicular to the target 130 and/or to an outer surface 134 of the vacuum window 132; substantially parallel to a propagation axis 111 of the electron beam 112; substantially colinear with the propagation axis 111). At least 70% (e.g., at least 80%; at least 90%; at least 95%) of the x-rays 114 of the first diverging x-ray beam 230 are within a first cone angle Θ₁ (e.g., symmetric about the x-ray axis 250) greater than or equal to 130 degrees (e.g., greater than or equal to 150 degrees; greater than or equal to 175 degrees; greater than or equal to 180 degrees). At least 70% (e.g., at least 80%; at least 90%; at least 95%) of the x-rays 22 of the second diverging x-ray beam 240 are within a second cone angle Θ₂ (e.g., symmetric about the x-ray axis 250) less than the first cone angle Θ₁ (e.g., the second diverging x-ray beam 240 is more collimated than is the first diverging x-ray beam 230; see, e.g., FIG. 3A). For example, the second cone angle Θ₂ can be: in a range of 2 degrees to 30 degrees; in a range of 2 degrees to 10 degrees; in a range of 6 degrees to 10 degrees; in a range of 10 degrees to 20 degrees; in a range of 20 degrees to 30 degrees.

In certain implementations, the x-ray source 100 and/or other portions of the x-ray tomography system 200 (e.g., the sample 202, rotational stage 210, and at least one x-ray detector 220) are configured to be moved relative to one another to tilt the x-ray axis 250 to have a non-zero tilt angle Φ relative to the central beam axis 222. The non-zero tilt angle Ø can be in a range of 0.5·Θ₂ to 0.5·Θ₁ (e.g., in a range of 5 degrees to 30 degrees; greater than 6 degrees; in a range of 10 degrees to 20 degrees; 15 degrees).

For example, the x-ray source 100 can be mounted to a translational and/or rotational stage configured to adjust the tilt angle Φ and/or the distance between the outer surface 134 of the vacuum window 132 and the at least one x-ray detector 220. For another example, the x-ray source 100 can remain stationary while the sample 202, rotational stage 210, and at least one x-ray detector 220 are moved to create a desired tilt angle Ø (e.g., using at least one translational and/or rotational stage). While FIG. 3A shows the x-ray source 100 tilted upwards (e.g., the x-ray axis 250 is below the central beam axis 222) with the rotation axis 212 in the plane that contains the central beam axis 222 and the x-ray axis 250, alternatively, the x-ray source 100 can be tilted downwards (e.g., the x-ray axis 250 is above the central beam axis 222) with the rotation axis 212 in the plane that contains the central beam axis 222 and the x-ray axis 250. In certain other implementations, the x-ray source 100 is tilted in another direction with the rotation axis 212 non-planar with the plane that contains the central beam axis 222 and the x-ray axis 250.

In certain implementations, the x-ray source 100 is tilted such that at least 70% (e.g., at least 80%; at least 90%; at least 95%; 100%) of the secondary x-rays (e.g., x-rays 22) are not incident on a region of the at least one x-ray detector 220 (e.g., a central region) configured to receive x-rays 114 from the sample 202 (e.g., the x-rays 22 are not incident on the at least one x-ray detector 220). For example, the x-ray source 100 can be tilted relative to the central beam axis 222 such that the tilt angle Φ between the central beam axis 222 and the x-ray axis 250 can be expressed as:

$$Φ \geq 0.5 \cdot ( {Θ}_{D} + {Θ}_{2} )$$

where Θ_{D} is an angle subtended by the region of the at least one x-ray detector 220 (e.g., symmetric about the central beam axis 222) and Θ₂ is the second cone angle of the second diverging x-ray beam 240. Using this relationship, for ΘD equal to 40 degrees and Θ₂ equal to 8 degrees, the tilt angle Φ can be greater than or equal to 24 degrees.

In certain implementations, the x-ray source 100 is tilted such that at least 70% (e.g., at least 80%; at least 90%; at least 95%; at least 99%; 100%) of the secondary x-rays (e.g., x-rays 22) are not incident on a central one-third region of the two-dimensional area of the at least one x-ray detector 220. For example, the x-ray source 100 can be tilted relative to the central beam axis 222 such that the tilt angle Ø between the central beam axis 222 and the x-ray axis 250 can be expressed as:

$$Φ \geq 0.5 \cdot [ ( 1 / 3 \cdot {Θ}_{D} ) + {Θ}_{2} ] .$$

Using this relationship, for Θ_{D} equal to 40 degrees and Θ₂ equal to 8 degrees, the tilt angle Φ can be greater than or equal to about 21.3 degrees. In certain such implementations, the effects of the secondary x-rays can be mitigated from the central region-of-interest (ROI) of the x-ray image but are not fully removed. The effects of the secondary x-rays can be further reduced by stitching with additional data and/or post-processing.

In certain implementations, the portion of the x-ray source 100 closest to the sample 202 (e.g., which can be referred to as the snout 106 of the x-ray source 100) and containing the vacuum window 132 is shaped to facilitate tilting of the x-ray source 100 relative to the central beam axis 222. For example, for relatively small samples 202 (see, e.g., FIG. 3A), the snout 106 can be substantially flat.

FIGS. 3B and 3C show an x-ray image and an x-ray lineout, respectively, of a portion of an example first diverging x-ray beam 230 and an example second diverging x-ray beam 240 in accordance with certain implementations described herein. The x-ray lineout is a plot of the x-ray intensity along a line 106 (e.g., dotted line in FIG. 3B) substantially perpendicular to the x-ray axis 250. The x-ray image and x-ray lineout were measured with the x-ray source 100 operating with a 120 kV electron beam 112 and a 300-nanometer spot size on the target 130, and with the x-ray source 100 and the at least one x-ray detector 220 aligned with one another (e.g., the central beam axis 222 and x-ray axis 250 coincident with one another) without a sample 202 between the x-ray source 100 and the at least one x-ray detector 220. As shown in FIG. 3B, the x-ray image resembles a central bright circular portion (e.g., due to the second diverging x-ray beam 240) encircled by a concentric circular ring portion (e.g., due to the first diverging x-ray beam 230) overlaying a non-zero intensity distribution. As shown in FIG. 3C, the x-ray lineout resembles a “top-hat” shape which can be used to measure the second cone angle Θ₂. For example, the diameter of the “top hat” shape (e.g., the diameter at the full-width-at-half-maximum or FWHM; the diameter at which the intensity is greater than 5% above the underlying non-zero intensity distribution) can be divided by the distance between the x-ray source 100 (e.g., the outer surface 134 of the x-ray window 132) and the at least one x-ray detector 220 to calculate the second cone angle Θ₂. Using the example values of a diameter of 17 millimeters and a distance of 220 millimeters, the second cone angle Θ₂ is approximately equal to 7.7 degrees.

In certain implementations, the portion of the x-ray source 100 closest to the sample 202 (e.g., which can be referred to as the snout 106 of the x-ray source 100) and containing the vacuum window 132 is shaped to facilitate tilting of the x-ray source 100 relative to the central beam axis 222. For example, for relatively small samples 202 (see, e.g., FIG. 3A) and/or samples 202 relatively distant from the x-ray source 100, the snout 106 does not appreciably inhibit tilting of the x-ray source 100, and the snout 106 can be substantially flat. However, using an x-ray source 100 with such a substantially flat snout 106 could inhibit tilting the x-ray source 100 with relatively large samples 202 and/or samples 202 that are relatively close to the x-ray source 100, thereby decreasing throughput and/or x-ray flux to the sample 202 and/or setting a maximum size of the sample 202.

FIG. 3D schematically illustrates an example x-ray source 100 with a substantially conical snout 106 in accordance with certain implementations described herein. The snout 106 comprises the vacuum window 132 and the portions of the vacuum chamber 102 to which the vacuum window 132 is affixed. In certain such implementations, the x-ray source 100 can be tilted (e.g., such that a portion of the conical snout 106 is substantially parallel to the sample 202). For example, as shown in FIG. 3D, the sample 202 can comprise a tall cylinder placed close (e.g., less than 10 millimeters; less than 5 millimeters; less than 2 millimeters; less than 1 millimeter) to the outer surface 134 of the vacuum window 132.

In certain implementations, the rotational stage 210 comprises a rotary stage (e.g., mechanical rotary stage; air-bearing rotary stage) and a three-axis (e.g., three orthogonal axes) translational positioning stage on the rotary stage. The rotary stage can be substantially stationary (e.g., affixed to a large granite slab). The rotary stage can have a runout of less than 150 nanometers (e.g., less than 100 nanometers; less than 50 nanometers) and the three-axis translational positioning stage can be configured to position the sample 202 relative to the center beam axis 222 and relative to the outer surface 134 of the vacuum window 132. The three-axis translational positioning stage can be configured to translate the sample 202 at least 40 millimeters (e.g., at least 50 millimeters; at least 100 millimeters) along each of the three axes.

In certain implementations, while submicron resolution imaging can be affected by non-zero runout (e.g., radial runout; axial runout) of the rotary stage, the rotations are sufficiently systematic such that calibration can be used to align tomography projections to correct for the runout and to achieve submicron (e.g., less than 1 micron; 0.5 micron; 0.3 micron) imaging. For example, a substantially spherical calibration sample (e.g., solder ball; ruby ball) can be placed at the rotation center at different locations along a y-axis (e.g., the rotation axis 212; perpendicular to a horizontal z-axis). The center-of-mass of the calibration sample can be measured at various locations along the y-axis and such measurements can be used to centershift the projections before reconstructing the tomography.

In certain implementations in which the x-ray source 100 is tilted and the rotation axis 212, central beam axis 222, and x-ray axis 250 are coplanar with one another (see, e.g., FIG. 3D), the sample 202 is movable in a range of positions in a direction substantially perpendicular to the central beam axis 222 (e.g., along the rotation axis 212) such that the sample 202 does not substantially intersect the second diverging x-ray beam 240 (e.g., which is centered about the x-ray axis 250). Due to the non-zero tilt angle Ø, this range of positions is wider for larger source-to-sample distances (e.g., distances between the outer surface 134 of the vacuum window 132 and the sample 202) than for smaller source-to-sample distances. In certain implementations, the three-axis translational positioning stage of the rotational stage 210 is configured to position the sample 202 such that the x-rays transmitted through a region-of-interest (ROI) of the sample 202 (e.g. the ROI imaged by the at least one x-ray detector 220) substantially comprise primary x-rays 114 (e.g., the primary x-rays 114 are more than 70%, more than 80%, more than 90%, more than 95%, or more than 99% of the x-rays transmitted through the ROI) for more than 50% of the source-to-sample distances.

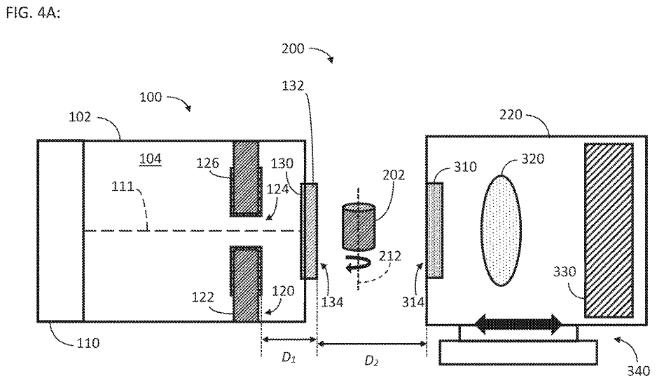

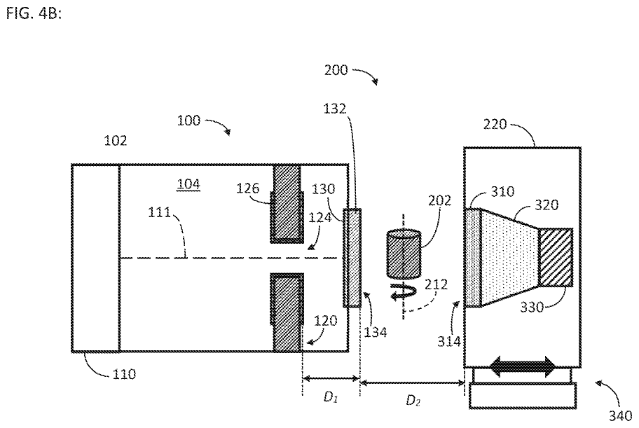

FIGS. 4A-4B schematically illustrate cross-sectional views of two examples of a transmission x-ray source 100 in accordance with certain implementations described herein. In certain implementations, the x-ray source 100 comprises an aperture 120 as described herein with regard to FIGS. 2A-2B, while in certain other implementations, the x-ray source 100 does not comprise an aperture 120. The aperture 120 can be a first distance D₁ from the vacuum window 132 (e.g., distance between a surface of the aperture 120 facing the target 130 and the outer surface 134 of the vacuum window 132 facing away from the target 130). For example, the first distance D₁ can be greater than 4 millimeters (e.g., in a range of 4 millimeters to 7 millimeters; greater than 7 millimeters; in a range of 5 millimeters to 20 millimeters; in a range of 20 millimeters to 50 millimeters; greater than 50 millimeters). The first distance D₁ can be sufficiently large to reduce (e.g., minimize) the flux of secondary x-rays 22 emitted from the x-ray source 100.

In certain implementations, the x-ray source 100 is part of an x-ray tomography system 200 comprising a rotational stage 210 and at least one x-ray detector 220, the rotational stage 210 configured to have a sample 202 mounted thereon and configured to rotate the sample 202 about a rotation axis 212. While the x-ray tomography systems 200 of FIGS. 4A-4B have the central beam axis 222 coincident with the x-ray axis 250 (e.g., the tilt angle Ø is substantially equal to zero), in certain other implementations, the x-ray source 100 and/or other portions of the x-ray tomography system 200 (e.g., the sample 202, rotational stage 210, and at least one x-ray detector 220) are configured to be moved relative to one another to tilt the x-ray axis 250 to have a non-zero angle Φ relative to the central beam axis 222, as discussed herein with regard to FIGS. 3A-3C. In certain implementations, the x-ray tomography system 200 comprises additional elements (e.g., x-ray attenuators; x-ray blockers) configured to prevent x-rays that impinge other structures besides the sample 202 (e.g., the rotational stage 210) from reaching the at least one x-ray detector 220.

In certain implementations, as shown in FIGS. 4A-4B, the at least one x-ray detector 220 comprises at least one scintillator 310, at least one optical element 320, and at least one visible light sensor 330. The at least one scintillator 310 (e.g., phosphor screen) has an outer surface 314 and is configured to receive x-rays from the sample 202 and to generate visible light in response to the received x-rays. In certain implementations, the phosphor screen comprises a single crystal material. In certain implementations, the phosphor screen comprises at least one material of the group consisting of: cesium iodide (e.g., CsI(Tl)), gadolinium oxysulfide (e.g., Gd₂O₂S; GadOx), gadolinium aluminum gallium garnet (GAGG), and yttrium aluminum garnet (YAG). In certain implementations, the phosphor screen can have a thickness in a direction substantially parallel to the central beam axis 222 that is less than or equal to 100 microns.

The at least one optical element 320 (e.g., an optical assembly) is configured to receive the visible light from the at least one scintillator 310 and to allow the visible light to propagate to the at least one visible light sensor 330. For example, as shown in FIG. 4A, the at least one optical element 320 comprises at least one lens (e.g., an objective lens), and as shown in FIG. 4B, the at least one optical element 320 comprises at least one optical fiber (e.g., fiber optic conduit). The at least one lens can comprise a high numerical aperture objective lens (e.g., similar to those used in visible light microscopes), with a magnification greater than or equal to 4× (e.g., in a range of 5× to 10×; in a range of 10× to 20×). The fiber optic conduit can be tapered and can produce a magnification greater than or equal to 0.3× (e.g., 0.3×; 0.5×; 1×; 1.5×; 2×; 3×). In certain implementations, the phosphor screen can have a thickness in a direction substantially parallel to the central beam axis 222 that is less than or equal to 5 times a depth-of-field of the at least one lens (e.g., less than or equal to 3 times the depth-of-field; less than or equal to 2 times the depth-of-field; less than or equal to the depth-of-field). In certain implementations, the phosphor screen of the at least one scintillator 310 has a thickness less than 200 microns (e.g., less than 150 microns; less than 100 microns; less than or equal to 50 microns).

The at least one visible light sensor 330 (e.g., spatially-resolving sensor; charge-coupled device (CCD) image sensor; complementary metal-oxide-semiconductor (CMOS) image sensor) is configured to respond to the visible light by generating electrical signals indicative of the x-rays received by the at least one x-ray detector 220 from the sample 202. The at least one visible light sensor 330 can have pixel sizes (e.g., width or diameter) less than 20 microns (e.g., less than 18 microns; less than 10 microns; in a range of 1 micron to 5 microns; less than 1 micron). Example visible light sensors 330 compatible with certain implementations described herein are available from Sony Corp. of Tokyo, Japan and GPixel Microelectronics Inc. of Changchun, China.

In certain implementations, the at least one visible light sensor 330 has pixel sizes greater than 10 microns, and the at least one scintillator 310, the at least one optical element 320, and the at least one visible light sensor 330 are arranged for a visible light magnification that produces an effective pixel size less than 20 microns (e.g., less than 18 microns; less than 10 microns; in a range of 1 micron to 5 microns; in a range of 2 microns to 5 microns; less than 5 microns; in a range of 1 micron to 2 microns; less than 1 micron; less than 0.5 micron; less than 0.3 micron; less than 0.15 micron). While FIGS. 4A-4B show the at least one visible light sensor 330 having a front face that is substantially parallel to the at least one scintillator 310, in certain other implementations, the front face of the at least one visible light sensor 330 can be at a non-zero angle (e.g., substantially perpendicular) to the at least one scintillator 310 (e.g., with the at least one optical element 320 comprising a 45-degree mirror).

In certain implementations, as shown in FIGS. 4A-4B, the at least one x-ray detector 220 is in mechanical communication with (e.g., affixed or mounted to) at least one controllable (e.g., motorized) translation stage 340 configured to controllably adjust a second distance D₂ (e.g., source-to-detector distance) between the vacuum window 132 and the at least one x-ray detector 220. For example, the second distance D₂ can be a distance between the outer surface 134 of the vacuum window 132 and an outer surface of the at least one x-ray detector 220 facing the sample 202 (e.g., the outer surface 314 of the at least one scintillator 310). In certain implementations, the at least one x-ray detector 220 can be positioned close to the sample 202. For example, the second distance D₂ can be less than 20 millimeters (e.g., less than 10 millimeters; less than 5 millimeters). Such second distances D₂ are smaller than the sample-to-detector distances used in conventional systems. For example, a conventional flat panel detector with 50-micron pixels can have a second distance D₂ of about 210 millimeters for a sample placed 3 millimeters from the x-ray source to achieve an imaging pixel resolution of about 0.7 micron. In contrast, an example x-ray detector 220 in accordance with certain implementations described herein having an effective pixel size of 1.7 microns can be used with a second distance D₂ of 4.3 millimeters (e.g., a reduction by almost a factor of 50) to produce the same imaging pixel resolution of about 0.7 micron from a sample 202 placed 3 millimeters from the x-ray source 100.

By utilizing smaller second distances D₂, certain implementations described herein can increase the number of primary x-rays 114 compared to the number of secondary x-rays 22 reaching the at least one x-ray detector 220. The fraction of the primary x-rays 114 generated by the target 130 that reach the outer surface 314 of the at least one scintillator 310 is inversely proportional to the square of the distance between the target 130 and the outer surface 314 of the at least one scintillator 310, which can be approximated to be substantially equal to the second distance D₂ (e.g., source-to-detector distance; distance between the outer surface 134 of the vacuum window 132 and an outer surface 314 of the at least one scintillator 310). In addition, the fraction of the secondary x-rays 22 generated by the aperture 120 that reach the outer surface 314 of the at least one scintillator 310 is inversely proportional to the square of the distance between the aperture 120 and the outer surface 314 of the at least one scintillator 310, which can be approximated to be substantially equal to the first distance D₁ plus the second distance D₂. Using these approximations, a suppression ratio R of secondary x-rays 22 to primary x-rays 114 reaching the outer surface 314 of the at least one scintillator 310 can be expressed as:

$$R = {D}_{2}^{2} / {( {D}_{1} + {D}_{2} )}^{2} .$$

In certain implementations, the suppression ratio R is less than 0.2 (e.g., less than 0.1; less than 0.01; less than 0.005; less than 0.002; less than 0.001). For example, with a first distance D₁ of 10 millimeters and a second distance D₂ of 4.3 millimeters, the suppression ratio R is approximately equal to 0.09, and can be used with the at least one x-ray detector 220 having an effective pixel width or diameter less than 10 microns (e.g., in a range of 1 micron to 5 microns; less than 5 microns; less than 1 micron). In comparison, the suppression ratio R for a conventional flat panel detector with a second distance D₂ of 220 millimeters would be 0.915.

In certain implementations, the target 130 is microstructural and comprises a plurality of discrete (e.g., separate; spaced from one another) regions of metal. For example, the electron beam 112 can be deflected between at least one region of the target 130 comprising at least one x-ray generating material and at least one non-target region with a low atomic number material (e.g., diamond; beryllium), the electron beam deflection can be used for “beam blanking” and can be used in combination with a secondary-to-primary suppression approach by using a small pixel detector placed at a small D₂ value.

In certain implementations, the at least one x-ray detector 220 comprises multiple x-ray detectors in mechanical communication with a translational and/or rotational stage configured to position a selected one of the multiple x-ray detectors 220 into position to receive x-rays from the sample 202. For example, a first x-ray detector 220 can have a first effective pixel size less than 10 microns (e.g., less than 5 microns) and a second x-ray detector (e.g., a conventional flat panel detector) can have a second effective pixel size greater than 40 microns (e.g., in a range of 50 microns to 100 microns) and/or a maximum field-of-view (FOV) greater than 100 millimeters in at least one lateral direction. The first x-ray detector 220 can be used for high resolution imaging at small D₂ values to suppress the contribution of the secondary x-ray beam 240. The second x-ray detector can be used for coarser resolution imaging with larger FOV (e.g., with a movable external aperture positioned between the x-ray source 100 and the sample 202).

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within +10% of, within +5% of, within +2% of, within +1% of, or within +0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

1. An apparatus comprising:
a transmission x-ray source comprising:
a window comprising a target layer of at least one x-ray generating material configured to generate a first diverging x-ray beam in response to bombardment by electrons, the first diverging x-ray beam emitted from the window and centered on an x-ray axis that is substantially perpendicular to an outer surface of the window; and
an internal aperture configured to allow a first portion of an electron beam from an electron beam source to bombard the target layer and to block a second portion of the electron beam from bombarding the target layer, the internal aperture generating a second diverging x-ray beam emitted from the window and centered on the x-ray axis, the first portion of the electron beam having a full-width-at-half-maximum width at the target layer less than or equal to 1 micron, the window spaced from the internal aperture by a first distance D₁, and
an x-ray detector system comprising:
a scintillator configured to receive x-rays from the transmission x-ray source that have propagated through a sample and to respond to the received x-rays by generating visible light;
an optical assembly configured to receive the visible light from the scintillator;
at least one image sensor configured to receive and respond to the visible light from the optical assembly by generating electrical signals; and
a motorized stage configured to controllably adjust a position of the scintillator such that the scintillator is spaced from the window by a second distance D₂, wherein
$${D}_{2}^{2} / {( {D}_{1} + {D}_{2} )}^{2}$$
is less than 0.2.

2. The apparatus of claim 1, wherein the x-ray axis is substantially perpendicular to the target layer.

3. The apparatus of claim 1, wherein the x-ray axis is substantially parallel to a propagation axis of the electron beam.

4. The apparatus of claim 1, wherein the x-ray axis is substantially colinear with a propagation axis of the electron beam.

5. The apparatus of claim 1, wherein at least 70% of x-rays of the first diverging x-ray beam are within a first cone angle greater than or equal to 130 degrees and at least 70% of x-rays of the second diverging x-ray beam are within a second cone angle in a range of 2 degrees to 30 degrees.

6. The apparatus of claim 1, wherein the first distance D₁ is in a range of 4 millimeters to 7 millimeters.

7. The apparatus of claim 6, wherein the second distance D₂ is in a range less than 5 millimeters.

8. The apparatus of claim 1, wherein the first distance D₁ is in a range greater than 50 millimeters.

9. The apparatus of claim 8, wherein the second distance D₂ is in a range less than 20 millimeters.

10. The apparatus of claim 1, wherein
$${D}_{2}^{2} / {( {D}_{1} + {D}_{2} )}^{2}$$
is less than 0.1.

11. The apparatus of claim 1, wherein
$${D}_{2}^{2} / {( {D}_{1} + {D}_{2} )}^{2}$$
is less than 0.01.

12. The apparatus of claim 1, wherein
$${D}_{2}^{2} / {( {D}_{1} + {D}_{2} )}^{2}$$
is less than 0.005.

13. The apparatus of claim 1, wherein
$${D}_{2}^{2} / {( {D}_{1} + {D}_{2} )}^{2}$$
is less than 0.002.

14. The apparatus of claim 1, wherein
$${D}_{2}^{2} / {( {D}_{1} + {D}_{2} )}^{2}$$
is less than 0.001.

15. The apparatus of claim 1, wherein the internal aperture comprises a solid slab or plate and a hole extending through the slab or plate and having a width substantially perpendicular to the electron beam less than 5 millimeters.

16. The apparatus of claim 15, wherein the hole has an asymmetric perimeter.

17. An apparatus comprising:
an x-ray source comprising:
an electron beam source configured to generate an electron beam;
at least one aperture configured to allow a first portion of the electron beam to propagate through the at least one aperture and to block a second portion of the electron beam from propagating through the at least one aperture;
at least one target comprising at least one x-ray generating material, the at least one x-ray generating material configured to generate a first diverging x-ray beam in response to bombardment by the first portion of the electron beam, the at least one aperture configured to generate a second diverging x-ray beam in response to bombardment by the second portion of the electron beam and/or by electrons backscattered from the at least one target; and
a window configured to emit the first x-ray beam and the second x-ray beam, both the first x-ray beam and the second x-ray beam substantially centered on an x-ray axis that is substantially perpendicular to an outer surface of the window;
a sample stage configured to support and controllably move a sample; and
at least one x-ray detector configured to receive x-rays of the first x-ray beam transmitted from the x-ray source and through a region-of-interest of the sample along a central beam axis, the central beam axis and the x-ray axis having an angle @ therebetween, the angle ¢ in a range of 15 degrees to 90 degrees.

18. The apparatus of claim 17, wherein at least 70% of x-rays of the first x-ray beam are within a first cone angle Θ₁, at least 70% of x-rays of the second x-ray beam are within a second cone angle Θ₂, and the angle Φ is in a range of 0.5·Θ₂ to 0.5·Θ₁.

19. The apparatus of claim 17, wherein the electron beam has a full-width-at-half-maximum spot diameter at the at least one target less than 0.3 micron.

20. The apparatus of claim 17, wherein a surface of the aperture facing the at least one target is spaced from an outer surface of the window facing away from the at least one target by a distance D₁ greater than 50 millimeters.

21. The apparatus of claim 20, further comprising at least one translation stage affixed to the at least one x-ray detector and configured to controllably adjust a second distance D₂ between the outer surface of the window and an outer surface of the at least one detector facing the sample, the second distance D₂ less than 10 millimeters.

22. The apparatus of claim 17, wherein the angle Φ is greater than or equal to 21.3 degrees.

23. The apparatus of claim 17, further comprising a translational and/or rotational stage, the x-ray source mounted to the translational and/or rotational stage, the translational and/or rotational stage configured to adjust the angle Φ.

24. An apparatus comprising:
a transmission x-ray source configured to generate a primary x-ray beam having a first cone angle Θ₁ and a secondary x-ray beam having a second cone angle Θ₂ less than the first cone angle Θ₁, both the primary x-ray beam and the secondary x-ray beam diverging and symmetric about an x-ray axis;
a sample stage configured to support and controllably move a sample; and
at least one x-ray detector having a region configured to receive x-rays transmitted from the transmission x-ray source and through a region-of-interest of the sample along a beam axis at a non-zero angle Φ relative to the x-ray axis, the at least one x-ray detector configured to generate electrical signals indicative of the x-rays received at the region, the angle Φ in a range of 15 degrees to 90 degrees.

25. The apparatus of claim 24, wherein the first cone angle Θ₁ is greater than or equal to 130 degrees and the second cone angle Θ₂ is in a range of 2 degrees to 30 degrees.

26. The apparatus of claim 24, wherein the angle ¢ is in a range of 0.5·Θ₂ to 0.5·Θ₁.

27. The apparatus of claim 24, wherein at least 70% of the secondary x-ray beam is not incident on the region of the at least one x-ray detector.

28. The apparatus of claim 27, wherein the non-zero angle Φ is greater than or equal to 24 degrees.
